(19) United States
(12) Patent Application Publication
(10) Pub. No.: US 2025/0117197 A1
(43) Pub. Date: Apr. 10, 2025

(54) ROBUST DATA PIPELINES THROUGH MODEL DRIVEN ENGINEERING

(71) Applicant: JP Morgan Chase Bank, N.A., New York, NY (US)

(72) Inventors: Vamshikrishna JANDHYALA, Tonbridge (GB); Jennifer R. SUTTLE, Wheaton, IL (US); Martin K. HELLEN, Twickenham (GB); Jia LIN, New York, NY (US); Swapnil Dilip PATANKAR, Thane (IN); Jack A. HIGGS, Orpington (GB); William NARMONTAS, London (GB); Hemal MEHTA, Singapore (SG)

(73) Assignee: JP Morgan Chase Bank, N.A., New York, NY (US)

(21) Appl. No.: 18/534,308

(22) Filed: Dec. 8, 2023

(30) Foreign Application Priority Data
Oct. 6, 2023 (IN) 202311067204

(51) Int. Cl. G06F 8/35; G06F 8/74

(52) U.S. Cl. CPC G06F 8/35; G06F 8/74

(57) ABSTRACT

A method for implementing robust data pipelines through model-driven engineering (MDE) is provided. The method may be implemented by at least one processor. The method may include receiving data at an MDE ecosystem; modelling the data to create a logical data model based on a meta model stored in a data catalog; storing the logical data model in the data catalog; generating a data in motion (DiM) library based on the logical data model; creating an original channel in the data catalog and registering the logical data model as a data contract on the original channel; receiving a transformation data flow into the data catalog in the MDE ecosystem, wherein a transformation process of the transformation data flow is performed outside of the MDE ecosystem; and using a reverse engineering tool to generate a new channel in the data catalog from the transformation data flow.

### CROSS-REFERENCE TO RELATED APPLICATION

This application claims benefit to Indian Patent Application number 202311067204, filed Oct. 6, 2023, which is incorporated herein in its entirety by reference.

### FIELD OF TECHNOLOGY

The present disclosure relates generally to data pipelines and, in particular, to generating robust data pipelines through Model Driven Engineering (MDE).

### BACKGROUND

MDE is a software methodology that focuses on creating and exploiting domain models, which are conceptual models of all the topics related to a specific problem. Domain models can be used to solve problems related to that specific domain. The domain model is a representation of meaningful real-world concepts pertinent to the domain that need to be modeled in software.

Domain models include the data involved in a business and rules the business uses in relation to that data. In creating the domain models, a key challenge can be the interoperability of data sources that do not have a common schema and that were collected, processed and analyzed under different methodologies. The integration process involves the integration of metadata and their data sets needed to be represented, but can also involve elements of coordination between people and knowledge domains that need to be included.

A series of actions can be taken by employing data management and data governance principles during the integration process of the data to define what data is integrated and how the data is integrated. Data management can be used by businesses to maximize the accessibility and usability of data and to treat data as an asset. Data governance can be implemented to manage data as an asset through the creation, transformation and usage of data.

Data governance has received increased attention as the quality of data meanwhile is increasingly being considered a key prerequisite for companies for being able to meet a number of strategic business requirements, such as developing and deploying a customer-centric business model. Data governance ensures that data is managed as an asset and transformed into meaningful information. Data governance principles should be maintained throughout the lifecycle of the data that is being governed in order to derive the benefits of managing quality data for better and faster decision-making.

As such, a need exists for robust data pipelines implemented through MDE, wherein the MDE can be adapted for the purpose of creating high quality streaming data pipelines that adhere to data governance.

### SUMMARY

The present disclosure, through one or more of its various aspects, embodiments, and/or specific features or sub-components, provides, inter alia, various systems, servers, devices, methods, media, programs, and platforms for implementing robust data pipelines through MDE.

In various embodiments, a system and method provide MDE that can be used in conjunction with reverse engineering and artificial intelligence/machine learning (AI/ML) techniques to create robust high quality data pipelines and corresponding semantic data flow graphs that enable advanced and context-aware computations and analyses.

In an embodiment, a method for implementing robust data pipelines through MDE is provided. The method may be implemented by at least one processor. The method may include receiving data at an MDE ecosystem; modelling the data to create a logical data model based on a meta model stored in a data catalog; storing the logical data model in the data catalog; generating a data in motion (DiM) library based on the logical data model; and creating an original channel in the data catalog and registering the logical data model as a data contract on the original channel. The method may also include receiving a transformation data flow into the data catalog in the MDE ecosystem, wherein a transformation process of the transformation data flow is performed outside of the MDE ecosystem; and using a reverse engineering tool to generate a new channel in the data catalog from the transformation data flow.

In an embodiment, a system may include a model authoring platform, a data catalog, a transport layer, a data control plane, and a reverse engineering tool. The model authoring platform may include a set of tools to enable a user to create a logical data model using a meta-meta model. In general, meta-meta modeling is an activity, and this activity produces meta-models, and the meta-meta model is the language that expresses the meta-model. The data catalog can be configured as a repository for storing the logical data model, a one data contract, a channel, and a consumer view.

The channel can link the data contract and the consumer view. The transport layer can be configured as a publish-subscribe message system. The data control plane can connect the transport layer and can be configured to authenticate publishers and consumers on the channel. The reverse engineering tool can be used to generate a new channel in the data catalog in an MDE ecosystem, based upon a transformation data flow received into the data catalog performed outside of the MDE ecosystem.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art based on the teachings provided.

### BRIEF DESCRIPTION OF THE DRAWINGS

Illustrative embodiments may take form in various components and arrangements of components. Illustrative embodiments are shown in the accompanying drawings, throughout which reference numerals may indicate corresponding or similar parts in the various drawings. The drawings are only for the purpose of illustrating the embodiments and are not to be construed as limiting the disclosure. Given the following enabling description of the drawings, the novel aspects of the present disclosure should become evident to a person of ordinary skill in the relevant art.

FIG. 1 shows an exemplary system for implementing robust data pipelines through MDE, according to an exemplary embodiment.

FIG. 2 is a flowchart of an exemplary process for implementing robust data pipelines through MDE, according to an exemplary embodiment.

FIG. 3A is an example of a model of a settlement transaction, according to an exemplary embodiment.

FIG. 3B illustrates sample rules for the model in FIG. 3A, according to an exemplary embodiment.

FIG. 4 is a flowchart of an exemplary process for implementing robust data pipelines through MDE used in conjunction with reverse engineering, according to an exemplary embodiment.

FIG. 5 illustrates an environment in which various embodiments can be implemented.

### DETAILED DESCRIPTION

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As described herein, various embodiments provide methods and systems for implementing robust streaming data pipelines through MDE. In various embodiments, the robust streaming data pipelines may be capable of analyzing, for example, millions of events in a fraction of time.

The streaming data involves the continuously generated data by numerous data sources. By using data streaming platforms, the data can be stored, processed, analyzed, and used to derive valuable insights.

The streaming data pipelines can enable continuous data ingestion, processing, and movement from the data source(s) into its destination as soon as the data is generated in real time. According to the present disclosure, the streaming data can include a wide variety of data such as log files generated by customers using mobile or web applications, ecommerce purchases, in-game player activity, information from social networks, financial trading floors, or geospatial services, and telemetry from connected devices or instrumentation in data centers.

The data can be processed sequentially and incrementally on a record-by-record basis or over sliding time windows, and used for a wide variety of analytics including correlations, aggregations, filtering, and sampling. The analytics retrieved from the data gives companies visibility into many aspects of their business and customer activity, such as service usage (for metering/billing), server activity, website clicks, and geo-location of devices, people, and physical goods.

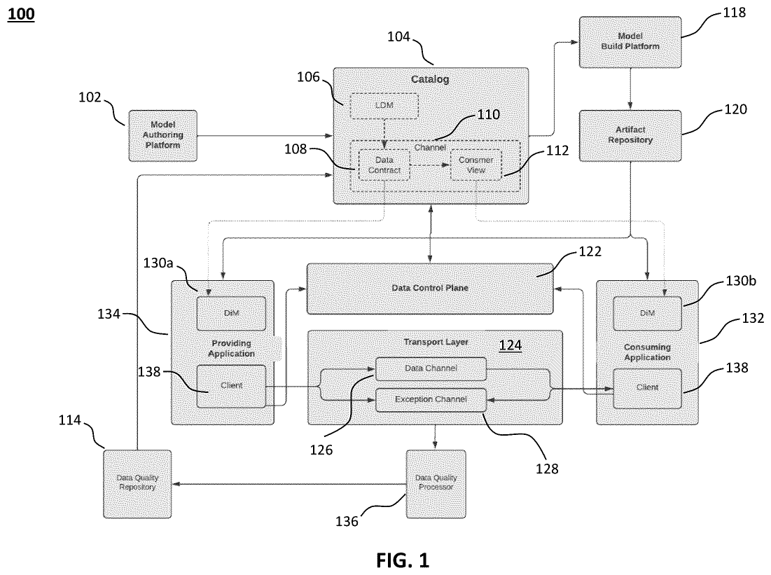

FIG. 1 is a block diagram of a system 100 for implementing robust data pipelines through MDE. The MDE can be employed as a software development methodology that focuses on creating and exploiting domain models, which are conceptual models of all the topics related to a specific problem. According to the present disclosure, MDE can be adapted for the purpose of creating high quality streaming data pipelines that adhere to data governance.

In FIG. 1, according to the present disclosure, the MDE can be used in conjunction with reverse engineering and AI/MI techniques to create robust high quality data pipelines and corresponding semantic data flow graphs that enable advanced and context-aware computations and analyses. The reverse engineering enabled by AI/MI will be discussed in detail below. The semantic data flow graph is a type of data flow graph that not only includes the flow of data through a system, but also the meaning and the relationships of the data and the entities involved. The data flow graph leverages the semantic technology to make sense of complex data sets, identifying the interconnections and dependencies among different data elements and providing a clear understanding of how changes in one part of the system might impact other parts.

The following list provides several examples of computations that the system 100 may perform on a semantic data flow graph in devices and/or methods according to the present disclosure.

Semantic Search. By using semantic information, the system 100 can conduct a more context-aware search on the data flow graph. For instance, if a query request is received for all data flows related to customer information, a semantic search can return not just the flows that explicitly involve a ‘customer’ entity, but also flows related to entities semantically connected to ‘customer’, such as ‘order’, ‘invoice’, ‘support ticket’, etc.

Debugging Data Pipelines. In data engineering, pipelines are frequently used to move and transform data from various sources to targets (e.g., databases, data lakes, data warehouses). Querying a data flow graph can help pinpoint bottlenecks, failures, or discrepancies in the data pipeline. The system 100 can be used to understand where the data is slowed or blocked and can be used to help diagnose and fix issues more effectively.

Impact Analysis. Impact analysis performed by system 100 can involve predicting the consequences of a change in one part of the data flow graph. By leveraging the semantic connections in the graph, the system 100 can help to determine not only which flows are directly affected by a change, but also which ones are indirectly impacted due to their semantic relationships.

Data Lineage and Provenance Tracking. The data flow graph of system 100 can be used to track the lineage of a piece of data—where it originated, what transformations it went through, and where it ended up. Semantic relationships can add context to this lineage, providing deeper insights into how and why the data has been used and transformed in particular ways.

Entity Resolution. Entity resolution involves identifying and linking different representations of the same entity. By using semantic relationships in the data flow graph, the system 100 can improve the accuracy and completeness of entity resolution, linking entities not just based on direct matches, but also based on their semantic context.

Anomaly Detection. The semantic data flow graphs can be used to detect anomalies in the data. By understanding the usual semantic patterns in the data flow, the system 100 can be used to more easily spot data or flows that deviate from these patterns.

Data Integration. Semantic data flow graphs can aid in data integration tasks. For instance, when merging data from two different systems, the semantic relationships in the data flow graphs can help map entities and relationships from one system to the other, even if they use different schemas or terminologies.

Distributed Systems Monitoring. In distributed systems, a data flow graph can illustrate how data moves between different services or microservices. Using system 100 to query such a graph can help monitor system performance, identify network bottlenecks, trace errors, and understand interdependencies among services.

Business Process Optimization. In the context of business intelligence, a data flow graph can represent the flow of data through various business processes (e.g., supply chain operations, customer service, etc.). Querying the graph helps in identifying inefficiencies, delays, or bottlenecks in these processes and can guide improvements and optimization efforts.

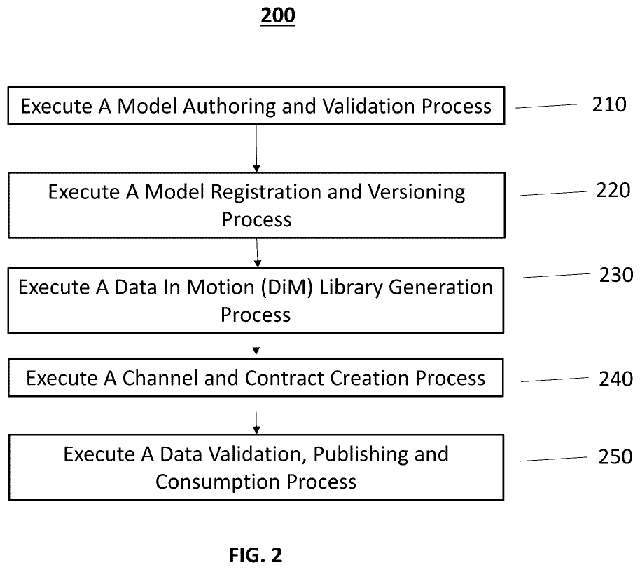

As shown in FIG. 2, the MDE process 200 for data pipelines can include, for example, the following sub processes: a model authoring and validation process 210, a model registration and versioning process 220, a data in motion (DiM) library generation process 230, a channel and contract creation process 240, and a data validation, publishing and consumption process 250.

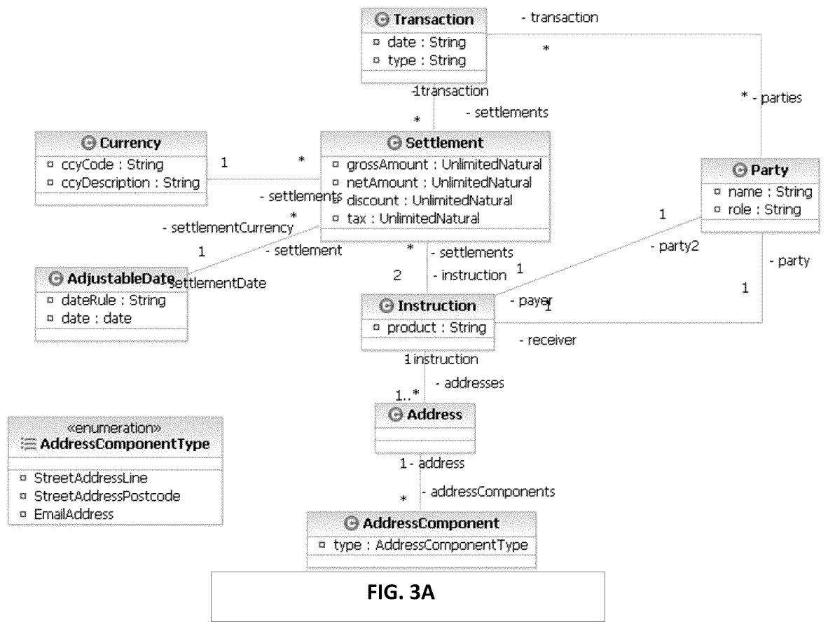

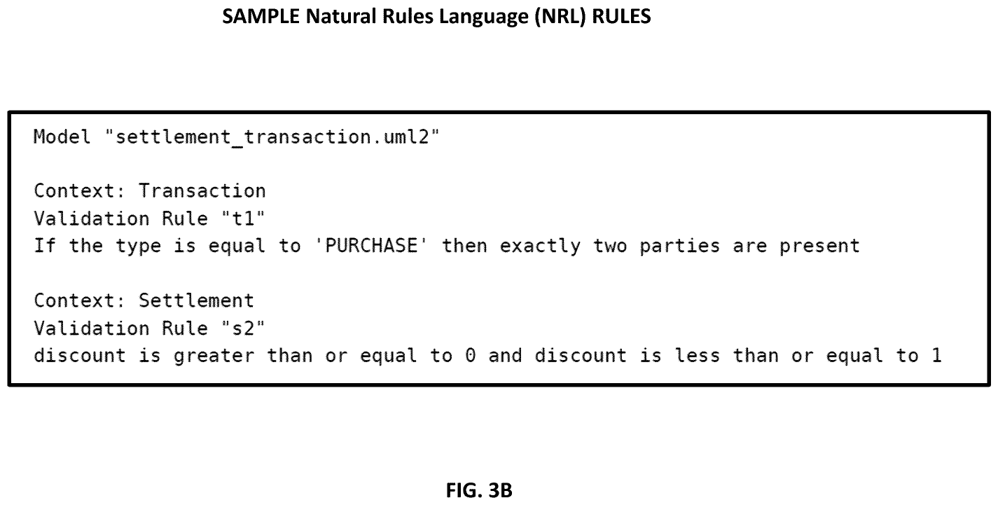

In block 210, the model authoring and validation process is executed, which is the first step in understanding the data to be able to model the data accurately and unambiguously. An expressive programming language agnostic meta-meta model can be used to formally specify models for data and metadata. The logical data modeling can be performed using, for example, a Unified Modeling Language (UML) or a Systems Modeling Language (SysML). Alternatively, a lightweight Domain Specific Language (DSL) (e.g., Pegasus Data Language) can be used for the logical data modeling. The meta model or the DSL can also be used to enable application developers/data stewards to annotate data models, create definitions, tag attributes as Personally Identifiable Information (PII)/Confidential. In addition to the logical data model, a set of data quality rules or constraints can also be specified using, for example, Natural Rules Language (NRL). In FIG. 3A, the UML diagram presents a simple generic model of a settlement transaction. Sample NRL rules for the model in FIG. 3A are shown in FIG. 3B.

In general, meta-meta modeling is an activity, and this activity produces meta-models, and the meta-meta model is the language that expresses the meta-model. The model is a truthful abstraction or a representation of a system to be developed. The purpose of modeling the logic and structure of software before the actual development is to identify possible logical fallacies, misunderstandings with the client, and to unravel system and environment requirements.

The modeling can be implemented in an architecture defined by the meta-model. In the modeling process, DSLs, Domain Specific Languages, can be used to describe the details of the project. DSLs are a subset of languages that are specialized for a certain domain.

Typically, the meta-model can include four layers built on each other. The first layer is the software itself to be developed. The next level is the level of the meta-model, which describes the software to be developed in an abstract, platform-independent manner. The next layer is the level of the meta-meta model. It is the language that is necessary for the definition of the meta-model. A meta-meta model has a different level of abstraction in order to make statements about the meta-model from another point of view. Finally, the last layer is the Meta Object Facility, which is a standard-type system for model-driven software engineering.

In various embodiments, the model-driven architecture provides the system of generalized models, which have been written in a modeling language. Its objective is to provide guidelines for structuring software specifications. It can be used by developers to effectively inspect the complete system for inconsistencies, errors or fallen structural concepts. Programmers can use a general-purpose modeling language, such as UML, (Unified Modeling Language) to describe a modeling language. However, if UML is not able to illustrate the modeling structures in a generalized way, with the use of model transformations, programmers can create interoperability between two meta-models.

In block 220, the model registration and versioning process is executed. Once a model is validated, the model can then be registered in a central Data Catalog. This registration enables transparency, auditability and facilitates reuse. Every update to the model should be versioned in the Data Catalog. The Data Catalog can be realized through the use of an application such as a Data Hub application. The Data Catalog provides the following features:
1. Search and Discovery of Data models.
2. Add/retrieve data definitions of entities, attributes and relationships.
3. Tag data models using a controlled vocabulary.
4. Visualize models, their relationships, lineage, etc.

In block 230, the DiM library generation process is executed. The next step in the process is generation of DiM libraries which are essentially class libraries in various programming languages (Python, Java, Typescript, etc.) based on a data model. Data provider applications can then embed the DiM libraries in their application to generate records that conform to the logical data models. The DiM library can also provide utility functions that enable producers/consumers to serialize/deserialize data, for example, into Avro, Parquet, XML or JSON as required. In addition, the DiM library can also provide the ability to validate the records against the data quality rules associated with the logical data models. A typical workflow is as follows:
1. User creates or edits a model and uploads it to the Data Catalog.
2. The Data Catalog detects changes, validates and registers a new version of the model.
3. User creates and runs a build pipeline against a versioned model to generate DiM libraries which are stored in an artifact repository.

In block 240, the channel and contract creation process is executed. The channel is a logical abstraction that links a Data Provider, a Data Contract, a set of consumers each having their own Consumer View (CV), and the details of the physical transport mechanism (e.g., Kafka broker and topic). The Data Contract is a logical data model that the providing application is guaranteed to adhere to. The Consumer View is a “subset” of the data contract on a given channel that the consumer is interested in.

The Data Catalog can enable Data Providers to create channels and consuming applications to subscribe to existing channels in a self-service fashion. The Data Provider application generates DiM libraries based on the Data Contract, and each consuming application on a channel generates a DiM library based on the Consumer View.

In block 250, the data validation and publishing process is executed. A typical workflow for a Streaming Data Provider is as follows:
1. Define a Logical Data Model.
2. Generate a DiM library based on the logical model.
3. Set up the physical transport mechanism e.g., Kafka cluster.
4. Create a channel in the Data Catalog—The Data Provider creates a channel in the Data Catalog and registers the logical data model created in block 1 as a Data Contract on that channel.
5. Create a provider application that embeds the DiM libraries and a client specific to the physical transport/programming language (e.g., Python Kafka client).
6. Validate a record created through the DiM against the data quality rules and publish exceptions on the exception channel corresponding to the data channel.
7. Publish validated records using the client on the data channel.

A typical workflow for a Streaming Data Consumer is as follows:
1. Search for data models and identify channels that transport data as per the required data model.
2. Define a Consumer View based on the Data Contract of the desired channel.
3. Register as a consumer against the channel.
4. Generate a DiM library based on the consumer view.
5. Create a consuming application that embeds the DiM libraries and a client specific to the physical transport/programming language (e.g., Python Kafka client).
6. Validate a record created through the DiM libraries against the data quality rules and publish exceptions on the exception channel corresponding to the data channel.
7. Consume validated records.

Referring back to FIG. 1, the example of system 100 is configured to provide robust data pipelines through MDE. In an embodiment, system 100 may include a model authoring platform 102, a data catalog 104, a data quality repository 114, a model build platform 118, an artifact repository 120, a data control plane 122, a transport layer 124, a consuming application 132, a providing application 134, and a data quality processor 136.

The model authoring platform 102 can provide a set of tools that enables information architects as well as application developers to create logical data models (LDM) 106 based on a standard meta model that can be stored and versioned in the data catalog 104. Examples of such tools are MagicDraw, Erwin, which are suitable for models of all complexity. For models of simple to medium complexity, a lightweight DSL can be used that is compatible with the standard meta model. One advantage of a lightweight DSL is that it can be validated through code editor extensions (e.g., VSCode, IntelliJ, etc.) and DiM libraries 130a, 130b can be generated either locally or through existing build pipelines which enables tight feedback loops and ensures that the model authoring is integrated with the existing software development lifecycle (SDLC) processes.

The data catalog 104 is one of the most important components of the architecture of system 100. The data catalog 104 functions as the central repository for all logical data models (LDM) 106, channels 110, their versions and the associated metadata (which uses controlled vocabulary). The LDM 106 can be composed of entity types, attributes, relationships, and domains. Each instance of these object types are uniquely identified and defined.

The definitions supply the semantic content for a data model. Through the use of sophisticated algorithms, the internal meta-model representation of the models enables computation of granular differences in the data model for versioning as well as compatibility checks between a producer view and the consumer views on a channel. The data catalog 104 facilitates search and discovery of models and channels.

In FIG. 1, the channel 110 is a logical abstraction that links a data contract 108 and a consumer view 112. The data contract 108 is a logical data model that the providing application 134 is guaranteed to adhere to. The consumer view 112 is a “subset” of the data contract 108 on a given channel 110 that the consumer is interested in. The channel 110 provides data quality scores against the channel which incentivizes providers to improve data quality and enables consumers to trust the data they are consuming. The data catalog 104 exposes the metadata through a property-graph model that can be easily queried for identifying dependencies, visualizing lineage, tracking downstream consumers, etc. The metadata in the data catalog 104 is continually enriched through human inputs as well as tags automatically generated through machine learning (ML) models trained on data available through the channels 110.

The model build platform 118 enables producers and consumers to generate a versioned DiM library 130a, 130b in one or more programming languages against any versioned model in the data catalog 104 and store it in the artifact repository 120.

The providing application 134 generates DiM libraries 130a based on the data contract 108, and each consuming application 132 on a channel generates a DiM library 130b based on the consumer view 112.

Client software development kits (SDKs) 138 provide common abstractions that work over multiple similar underlying transport layers 124 e.g., publish-subscribe (pub/sub) and messaging systems. One of the main roles of the client SDKs 138 is to authenticate publishers and consumers on a data channel 126 by connecting to the data control plane 122 for authentication and help serialize records to the underlying transport layer 124. The client SDKs 138 can also help the consumers migrate from one transport to another.

The streaming transport layer 124 can be an event streaming platform capable of ingesting and processing streaming data to build real-time data streaming pipelines or any other messaging platform that enables one publisher to exchange data asynchronously with multiple consumers using a publish-subscribe model.

The data control plane 122 helps authenticate providers and consumers before they publish to the data channel 126. The data control plane 122 also tracks channel usage as well as telemetry. The data captured in the data control plane 122 is made available to the data catalog 104.

The data quality processor 136 consumes and processes exception messages from the exception channels 128 and then persists the results in normalized fashion in the data quality repository 114. The data quality processor 136 provides labelled training data for AI/ML models which can help with automatic anomaly detection or auto-generation of additional data quality constraints.

The data quality repository 114 stores exception records received from the exception channels 128 and keeps track of data quality metrics for all channels that can be exposed through the data catalog 104.

Employing the MDE provides a number of benefits including data model discovery and reuse, controlled model evolution, automated evergreen fine grain data lineage, automatic code generation, multiple serialization options, and embedded data quality.

The data model discovery and reuse involves well defined data models centrally stored in a data catalog 104 that enables a shared understanding of data across the organization. Business domain data once formally modelled can be reused across multiple applications. By making the models and channels discoverable, the need to create new data pipelines also reduces as new consumers can start consuming data from existing channels 110.

In the controlled model evolution, the data provider on a channel 110 has an obligation to produce records which comply with the channel contract. As the channel contract is formally specified, any model changes on the provider end can be automatically checked for compliance against the data contract 108. The consumer views (CV) 112 also shield the consumers from any changes to attributes in the data contract 108 outside of what is being consumed. Automatic compatibility checking between data contracts 108 and consumer views 112 enable providers to make changes to the data contract 108 confidently without impacting any of the consumers of a given channel 110.

With regard to the automated evergreen fine grained data lineage, typically on a channel 110, multiple consumers can consume data provided by a data provider. Every consumer can potentially consume a different subset of attributes in the data contract 108 using their own consumer view 112. As all the consumer views 112 against a channel 110 are registered in the data catalog 104, the system 100 can provide fine grained attribute level lineage between providers and consumers. All provider applications 134/consumer applications 132 of a given channel are authenticated with the data control plane 122 at run time before publishing/consumption of records. This enables the identification of channels which have not been used recently.

Automatic code generation automatically generates standards compliant serializing and deserializing code for multiple languages from the model which saves the providers and consumers from a lot of boilerplate code.

The benefit of multiple serialization options is that, in most cases, the providers and the consumers do not have to worry about data serialization, but they have the flexibility to choose specific serialization formats (Avro, JSON, XML, etc.) for their use case as they see fit.

Embedded data quality is provided so that data quality is not an afterthought but instead tightly integrated with the data modelling/publishing/consumption process. Both the consumer and the publishers can validate records published/consumed on a data channel against the data quality rules associated with the data model and to publish exception records on the corresponding exception channel. The records in the exception channel 128 can be analyzed and stored for the purposes of data quality scoring and remediation. The data quality scores for channels can also be made available through the data catalog 104 to enable the consumers to get a better understanding of the quality of data being published on the channels 110 they are interested in.

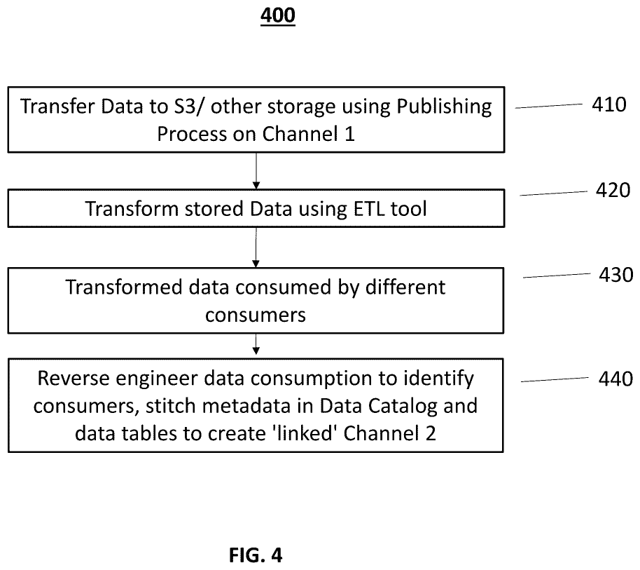

According to the present disclosure and as shown in FIG. 4, various embodiments of the MDE can be coupled with reverse engineering enabled by AI/ML. Various embodiments can be used to reverse-engineer the code (or other low-level artifacts of the initial system) into models. Reverse engineering can be employed very early in the process to quickly obtain the raw models representing the artifacts of the initial system without losing any of the information required for the process to ensure a common understanding of their contents. The raw models can then be used as inputs for chains of MDE operations, e.g., model transformations, in order to navigate, identify and extract the relevant information.

The transformation of the data into models can be combined and integrated into an MDE ecosystem. The objective of the representations of the models is to have a better understanding of the current state of the MDE ecosystem, for instance to correct it (e.g., to fix bugs or ensure regular maintenance), update it (e.g., to align it with the constantly evolving organizational policies and rules), upgrade it (e.g., to add new features or additional capabilities), reuse parts of it in other systems, or even completely re-engineer it.

In forward engineering, models are used to specify systems prior to their implementation. In comparison, reverse engineering builds and uses models from the system implementation, thus directly benefitting from these higher-level views of the system (e.g., design models) or of its domain (e.g., application domain models) in order to improve maintenance and evolution processes.

In various embodiments, the MDE with reverse engineering involves model discovery phase and a model understanding phase. The model discovery phase is used to discover different types of initial models from the legacy artifacts composing a given system, and the model understanding phase understands or processes these initial models to generate relevant views (i.e., derived models) on this system.

While forward engineering through the MDE can work with single hop data flows and multiple providers to multiple consumer streaming data flows, in some cases, there are pipelines involving complex transformations using custom code. For example, there may be a data flow where an on-premises (on-prem) application is transferring nested data from an on-prem application to a public cloud storage resource, such as buckets which in turn is processed through extraction, transformation and loading (ETL) tools and the final dataset is stored and distributed through a cloud data warehouse.

In general, the basic storage units can be objects which are organized into buckets. A serverless data integration service can be used to discover, prepare, move, and integrate data from multiple sources. The ETL is an important component of the data warehouse. A large amount of data can be loaded daily into the data warehouse from different sources which makes data quality important in almost all forms of data analytics. Therefore, data scrubbing in ETL is important because the data quality issue should be addressed before the data is stacked into the data warehouse.

By employing MDE according to the present disclosures, the approach herein basically relies on three main notions: metamodel, model and model transformation. The metamodel defines the possible element types and structure of the models which conform to it, similarly to the relationship between a grammar and corresponding programs in the programming field. Model transformations can be, for example, model-to-model. These raw models can be displayed as (full or partial) abstract syntax graphs that bridge the source code and the models.

The graph structure can be generated based on dependencies in the source code so that components can be reconstructed using pattern matching or clustering. From this point on in the process, reverse engineering can be performed on the system using the raw models as a valid input representation. The raw models can then be used as inputs for chains of the MDE operations, e.g., model transformations, in order to navigate, identify and extract the relevant information using an external ETL tool.

The external ETL tool can be components of the model discovery phase that can be either jointly or adapted to be plugged into the framework of the MDE ecosystem.

In operation using MDE according to an example of the present disclosure, the data can be modelled and transferred to the buckets using a first data channel (Channel 1) that is registered in the catalog. As the transformation can be performed through an external ETL tools outside of the MDE ecosystem so that there is no visibility into this part of the data flow into the data catalog. There is little or no insight on how the analytics are actually executed.

This makes verification of the data and its adherence to the data governance a difficult and error-prone task. Thus, the transformation is hidden to the developers and architects, which can impair the capacity of providing accountable and reproducible solutions. This is where reverse engineering can be employed. By reverse engineering the data in the public cloud storage resource (the buckets), metadata in the catalog of a data integration service and the tables in the cloud data warehouse, a new flow can be created in the data catalog which links the table in the cloud data warehouse to the first data channel (Channel 1).

The metadata from the original channel can be combined with the metadata automatically derived by AI/ML models in the data quality processor to link data elements in the logical data model of Channel 1 automatically with the reverse engineered physical data model of a second data channel (Channel 2) that is automatically created.

The logical data model provides a detailed, structured description of data elements and the connections between them. The logical data model diagram/schema contains all of the entities, attributes, and relationships in a visual representation. The logical data model is the basis for developing the physical model, but the logical data model does not take part in implementing the database. The physical data model specifies how the data model will be built in the database. The physical data model outlines all table structures, including column name, data types, column constraints, primary key and foreign key with indexes to the relevant table column, relationships between tables, stored procedures, and views.

Once the new channel (Channel 2) is automatically created in the data catalog, as described above, the following information can be automatically computed:
1. New data elements introduced in the transformation process excluding the data elements received on Channel 1.
2. Checking if the data elements introduced in the transformation process are already available through one of the registered sources in the data catalog.

FIG. 4 is a flowchart of an exemplary process 400 for implementing MDE used in conjunction with reverse engineering. In step 410, the process transfers the data to the buckets or other storage using the publishing process on Channel 1. In step 420, the process transforms the stored data using the ETL tool. In step 430, the transformed data is consumed by different consumers. In step 440, the process employs reverse engineering data consumption to identify consumer, stitch metadata in the data catalog and the data tables to create the linked Channel 2, which is a new automatically created channel.

The following list provides several techniques that have been proposed for future applications of systems, devices, and methods according to the present disclosure.
1. Unifying APIs and data flows under the channel abstraction
2. Provenance of features for AI/ML models
3. Partial automation of Model Card generation for Model reporting using metadata in the Catalog
4. Synthetic data generation on demand based on logical data models and metadata in the Catalog
5. Automatic suggestion of data quality rules in natural language based on analysis of data quality exceptions
6. Enforcing data entitlements across multiple physical data model contexts by declaring data policies once in the logical data model
7. Automatic policy recommendation based on analysis of data and metadata

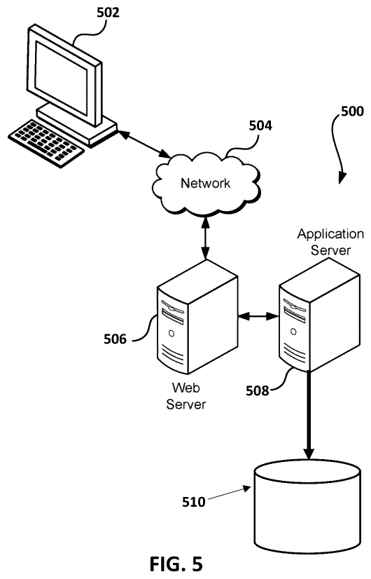

FIG. 5 illustrates aspects of an example environment 500 for implementing aspects in accordance with various embodiments. As will be appreciated, although a web-based environment is used for purposes of explanation, different environments may be used, as appropriate, to implement various embodiments. The environment includes an electronic device 502, which can include any appropriate device operable to send and/or receive requests, messages, or information over an appropriate network 504. In some embodiments, an appropriate device may convey information back to a user of the device. Examples of such electronic devices 502 include personal computers, cell phones, handheld messaging devices, laptop computers, tablet computers, set-top boxes, personal data assistants, embedded computer systems, electronic book readers, and the like.

The network 504 can include any appropriate network, including an intranet, the Internet, a cellular network, a local area network, a satellite network, or any other such network and/or combination thereof. Components used for such a system can depend at least in part upon the type of network and/or environment selected. Many protocols and components for communicating via such a network are well known and will not be discussed herein in detail.

Communication over the network can be enabled by wired or wireless connections and combinations thereof. In this example, the network 504 includes the Internet and/or other publicly addressable communications network, as the environment includes a web server 506 for receiving requests and serving content in response thereto, although for other networks an alternative device serving a similar purpose could be used as would be apparent to one of ordinary skill in the art.

The illustrative environment includes at least one application server 508 and a data store 510. It should be understood that there can be several application servers, layers or other elements, processes, or components, which may be chained or otherwise configured, that can interact to perform tasks such as obtaining data from an appropriate data store.

Servers, as used herein, may be implemented in various ways, such as hardware devices or virtual computer systems. In some contexts, servers may refer to a programming module being executed on a computer system. As used herein, unless otherwise stated or clear from context, the term “datastore” or “data store” refers to any device or combination of devices capable of storing, accessing, and retrieving data, which may include any combination and number of data servers, databases, data storage devices, and data storage media, in any standard, distributed, virtual, or clustered environment.

The application server 508 can include any appropriate hardware/software/firmware for integrating with the data store 510 needed to execute aspects of applications for the electronic device 502, handling some or all of the data access and logic for an application. The application server 508 may provide access control services in cooperation with the data store 510. It can also generate content including, but not limited to, text, graphics, audio, video, and/or other content usable to be provided to the user. Such content may be served to the user by the web server in the form of Hypertext Markup Language (“HTML”), Extensible Markup Language (“XML”), JavaScript, Cascading Style Sheets (“CSS”), JavaScript Object Notation (JSON), and/or another appropriate client-side structured language.

Content transferred to an electronic device 502 may be processed by the electronic device 502 to provide the content in one or more forms including, but not limited to, forms that are perceptible to the user audibly, visually, and/or through other senses. The handling of all requests and responses, as well as the delivery of content between the electronic device 502 and the application server 508, can be handled by the web server using PHP: Hypertext Preprocessor (“PHP”), Python, Ruby, Perl, Java, HTML, XML, JSON, and/or another appropriate server-side structured language in this example. Further, operations described herein as being performed by a single device may, unless otherwise clear from context, be performed collectively by multiple devices, which may form a distributed and/or virtual system.

The environment, in one embodiment, is a distributed and/or virtual computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 5. Thus, the depiction of the system illustrated in the example environment 500 in FIG. 5 should be taken as being illustrative in nature and not limiting to the scope of the disclosure.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for implementing robust data pipelines through model-driven engineering (MDE), the method comprising:
receiving data at an MDE ecosystem;
modelling, by at least one processor, the data to create at least one logical data model based on a meta model stored in a data catalog;
storing, by the at least one processor, the at least one logical data model in the data catalog;
generating, by the at least one processor, a data in motion (DiM) library based on the at least one logical data model;
creating, by the at least one processor, an original channel in the data catalog and registering the at least one logical data model as a data contract on the original channel;
receiving a transformation data flow into the data catalog in the MDE ecosystem, wherein a transformation process of the transformation data flow is performed outside of the MDE ecosystem; and
using a reverse engineering tool to generate a new channel in the data catalog from the transformation data flow.

2. The method of claim 1, wherein the generating the new channel in the data catalog further comprises automatically computing:
new data elements introduced in the transformation process, excluding data elements of the original channel registered in the data catalog; and
determining whether the new data elements are already available through one of a plurality of registered sources in the data catalog.

3. The method of claim 1, wherein the generating the new channel in the data catalog further comprises using MDE to model data and transfer the data via the original channel registered in the data catalog.

4. The method of claim 3, wherein the generating the new channel in the data catalog further comprises reverse engineering data stored in a public cloud storage, metadata stored in a catalog of a data integration service, and tabular data stored in a cloud data warehouse to generate a reverse engineered physical data model of a different channel, wherein the different channel is different from the original channel and the new channel.

5. The method of claim 4, wherein generating the new channel in the data catalog further comprises creating a new data flow configured to link the tabular data stored in the cloud data warehouse to the original channel.

6. The method of claim 5, wherein generating the new channel in the data catalog further comprises linking data elements in the logical data model of the original channel with the reverse engineered physical data model of the different channel.

7. The method of claim 1, wherein modelling the data further comprises executing a model authoring and validation process.

8. The method of claim 7, wherein the meta model is further configured to enable a user to specify data quality rules or constraints for at least one logical data model.

9. The method of claim 1, wherein storing the at least one logical data model further comprises executing a model registration and versioning process.

10. The method of claim 1, wherein generating the DiM library further comprises executing a code generation process.

11. The method of claim 10, wherein the DiM library is configured as class libraries in a plurality of programming languages based on the at least one logical data model.

12. The method of claim 1, wherein creating the original channel further comprises executing a channel and contract creation process.

13. The method of claim 1, further executing, by the at least one processor, a data validation, publishing and consumption process.

14. The method of claim 13, wherein executing the data validation, publishing and consumption process further comprises executing a workflow process for a streaming data provider that includes:
defining the at least one logical data model;
generating the DiM library based on the at least one logical data model;
setting up a physical transport mechanism;
creating the original channel in the data catalog and registering the logical data model as the data contract on the original channel;
creating a provider application configured to embed the DiM library and a client specific to the physical transport mechanism or a programming language;
validating a record created through the DiM library against one or more data quality rules and publish exceptions on an exception channel corresponding to a data channel; and
publishing the validated records using the client on the data channel.

15. The method of claim 13, wherein executing the data validation, publishing and consumption process further comprises executing a workflow process for a streaming data consumer that includes:
searching for the at least one data model and identifying one or more channels that transport data per a required at least one data model;
registering as a consumer against an existing channel;
defining a consumer view based on the data contract of the original channel;
generating the DiM library based on the consumer view;
creating a consuming application configured to embed the DiM library and a client specific to the physical transport mechanism or a programming language;
validating a record created through the DiM library against one or more data quality rules and publish exceptions on an exception channel corresponding to a data channel; and
consuming the validated records.

16. A system comprising:
a model authoring platform including a set of tools configured to enable a user to create a logical data model using a meta-meta model;
a data catalog configured as a repository for storing the logical data model, a data contract, an original channel, and a consumer view, wherein the original channel is configured to link the data contract and the consumer view;
a transport layer configured as a publish-subscribe message system;
a data control plane configured to connect to the transport layer and to authenticate publishers and consumers on the original channel; and
a reverse engineering tool configured to generate a new channel in the data catalog in a model-driven engineering (MDE) ecosystem, based upon a transformation data flow received into the data catalog performed outside of the MDE ecosystem.

17. The system of claim 16, wherein the reverse engineering tool is further configured to generate the new channel in the data catalog further comprises automatically computing:
new data elements introduced in the transformation process, excluding data elements of the original channel registered in the data catalog; and
determining whether the new data elements are already available through one of a plurality of registered sources in the data catalog.

18. The system of claim 16, further comprising a model build platform and an artifact repository configured to generate a versioned data in motion (DiM) library using one or more programming languages stored against any versioned model in the data catalog and to store the versioned DiM library in the artifact repository.

19. The system of claim 16, further comprising:
a data quality processor configured to consume and process exception messages from an exception channel of the transport layer and to generate exception records; and
a data quality repository configured to store the exception records and to monitor and record data quality metrics for all channels exposed through the data catalog.

20. A tangible computer-readable medium having stored thereon, computer executable instructions that, if executed by a computing device, cause the computing device to perform a method for implementing robust data pipelines through model-driven engineering (MDE), the method comprising:
receiving data at an MDE ecosystem;
modelling, by at least one processor, the data to create at least one logical data model based on a meta model stored in a data catalog;
storing, by the at least one processor, the at least one logical data model in the data catalog;
generating, by the at least one processor, a data in motion (DiM) library based on the at least one logical data model;
creating, by the at least one processor, an original channel in the data catalog and registering the at least one logical data model as a data contract on the original channel;
receiving a transformation data flow into the data catalog in the MDE ecosystem, wherein a transformation process of the transformation data flow is performed outside of the MDE ecosystem; and
using a reverse engineering tool to generate a new channel in the data catalog from the transformation data flow.
